(19) United States
(12) Patent Application Publication
(10) Pub. No.: US 2024/0210910 A1
(43) Pub. Date: Jun. 27, 2024

(54) DATA PROCESSING DEVICE, DATA PROCESSING METHOD, AND STORAGE MEDIUM

(71) Applicant: Mitsubishi Electric Corporation, Tokyo (JP)

(72) Inventor: Hidematsu HAYASHI, Tokyo (JP)

(73) Assignee: Mitsubishi Electric Corporation, Tokyo (JP)

(21) Appl. No.: 17/913,897

(22) PCT Filed: Aug. 26, 2020
(86) PCT No.: PCT/JP2020/032241

§ 371 Date: Sep. 23, 2022

(51) Int. Cl. G05B 19/406; G06F 18/241

(52) U.S. Cl. CPC G05B 19/406; G06F 18/241; G05B 2219/31449; G05B 2219/37434

(57) ABSTRACT

A data processing device includes: an observation data collection unit collecting observation data; a data classification unit classifying the observation data into analysis target data pieces for each management item as a determination-used unit for a production facility status; a feature data extraction unit analyzing each analysis target data piece and extracts feature data representing a feature of an operation corresponding to each management item; a learning model generation unit generating a learning model for determination of the production facility status for each management item based on the feature data; an observation data determination unit determining the production facility status for each management item based on a learning model for each management item and observation data newly collected; and a data output unit outputting a determination result of the status for each management item.

### FIELD

The present disclosure relates to a data processing device, a data processing method, and a data processing program for analyzing an observation result obtained by a sensor attached to a production facility so as to determine an operation state of the production facility.

### BACKGROUND

Conventionally, setting change for improving productivity, identification of a defect cause, and the like have been performed by acquiring operation data representing an operational status from a production facility and analyzing the operation data. However, some of the production facilities do not have a data output function. Therefore, data analysis has been performed by, as an alternative method for acquiring operation data of a production facility having no data output function, using a method of attaching a sensor to a product outlet of the production facility and acquiring only operation data indicating product completion based on detection of the sensor, or by using a method of acquiring an electric current waveform from the production facility and sound (a sound wave) emitted from the production facility. Note that, in the case of data analysis using a current waveform or sound, a difference from a normal current waveform or sound waveform has been detected as an anomaly, and has been determined as an anomaly of the production facility.

Patent Literature 1 describes a facility management device that determines an operational status of a production facility on the basis of data outputted from a sensor installed in the production facility such as a machine tool. The facility management device described in Patent Literature 1 includes: a data acquisition unit for acquiring data relating to an operational status of a device (a production facility); a feature amount extraction unit for extracting a feature amount on the basis of data acquired by the data acquisition unit; a clustering unit for classifying the feature amount extracted by the feature amount extraction unit to create a cluster; a labeled-data creating unit for creating data in which the feature amount classified by the clustering unit are labeled with the operational status of a clustered device to which the feature amount obtained by the classification belongs; a memory unit for storing data created by the labeled-data creating unit; and a status determining unit for determining an operational status of the device on the basis of the feature amount extracted by the feature amount extraction unit and the data stored in the memory unit and outputting the determination result.

### CITATION LIST

### Patent Literature

Patent Literature 1: International Publication No. 2017/090098 (WO 2017/090098)

### SUMMARY

### Technical Problem

The facility management device described in Patent Literature 1 can determine that the production facility is in a specific status such as a status in which a defect occurs. However, a status of each of a series of operations performed by the production facility is not individually determined. Therefore, for example, in order to improve the productivity, it has not been possible to determine a state of each of a series of operations from the production facility and analyze which operation thereof is a bottleneck in achieving the productivity improvement.

The present disclosure has been made in view of the above circumstances, and an object thereof is to provide a data processing device capable of individually determining a status of each of a series of operations performed by a production facility.

### Solution to Problem

In order to solve the above-mentioned problems and achieve the object, the present disclosure provides a data processing device comprising: an observation data collection unit to collect observation data on vibration caused during operation of a production facility; a data classification unit to classify the observation data into a plurality of pieces of analysis target data for each of management items each of which is a unit in which an operational status of the production facility is to be determined; a feature data extraction unit to analyze each of the pieces of analysis target data and extract feature data representing a feature of an operation corresponding to each of the management items; a learning model generation unit to generate, based on the feature data, a learning model for determination of an operational status of the production facility for each of the management items; an observation data determination unit to determine an operational status of the production facility for each of the management items, based on a learning model for each of the management items and observation data newly collected by the observation data collection unit, the learning model being generated by the learning model generation unit; and a data output unit to output a determination result of an operational status for each of the management items, the determination result being obtained by the observation data determination unit.

### Advantageous Effects of Invention

A data processing device according to the present disclosure has an advantageous effect that it can individually determine a status of each of a series of operations performed by a production facility.

### BRIEF DESCRIPTION OF DRAWINGS

FIG. 1 is a diagram illustrating a configuration example of a data collection system to which a data processing device according to an embodiment is applied.

FIG. 2 is a diagram illustrating a configuration example of the data processing device according to the embodiment.

FIG. 3 is a chart illustrating an example of a screen displayed by a display operation unit.

FIG. 4 is a diagram illustrating an operation outline of a learning stage of the data processing device.

FIG. 5 is a flowchart illustrating an example of an operation in the learning stage of the data processing device.

FIG. 6 is a first diagram illustrating an operation outline of a determination stage of the data processing device.

FIG. 7 is a second diagram illustrating an operation outline of the determination stage of the data processing device.

FIG. 8 is a flowchart illustrating an example of an operation in the determination stage of the data processing device.

FIG. 9 is a diagram illustrating an example of hardware that realizes the data processing device.

### DESCRIPTION OF EMBODIMENTS

Hereinafter, a data processing device, a data processing method, and a data processing program according to an embodiment of the present disclosure will be described in detail with reference to the drawings.

### Embodiment

First, an outline of a data processing device according to the present embodiment will be described. The data processing device according to the present embodiment analyzes measurement data of vibration generated from a production facility at a manufacturing site, to output an operational status of the production facility as data. The vibration here is sound and mechanical vibration. The sound includes not only an audible sound but also an ultrasonic sound wave. The data processing device analyzes measurement data of one or both of sound and mechanical vibration caused from the production facility. In a case where a product is produced in a production facility, when operation of an internal mechanism of the production facility, processing of a workpiece, assembly of a workpiece, or the like is implemented, sound and mechanical vibration according to these implementation statuses occur in the production facility. In addition, when a defect of an internal mechanism of the production facility, a processing defect of a workpiece, an assembly defect, or the like occurs, the corresponding defect status appears in sound or mechanical vibration. That is, an anomaly of the production facility can be detected by observing the sound or the mechanical vibration caused in the production facility. Therefore, the data processing device according to the present embodiment collects at least one of observation data of sound or observation data of mechanical vibration, as data representing a status of the production facility, and analyzes the collected observation data by utilizing artificial intelligence (AI), so as to determine an operational status on, for example, whether or not the production facility is normally operated. At this time, the data processing device determines an operational status of each of a series of operations executed by the production facility.

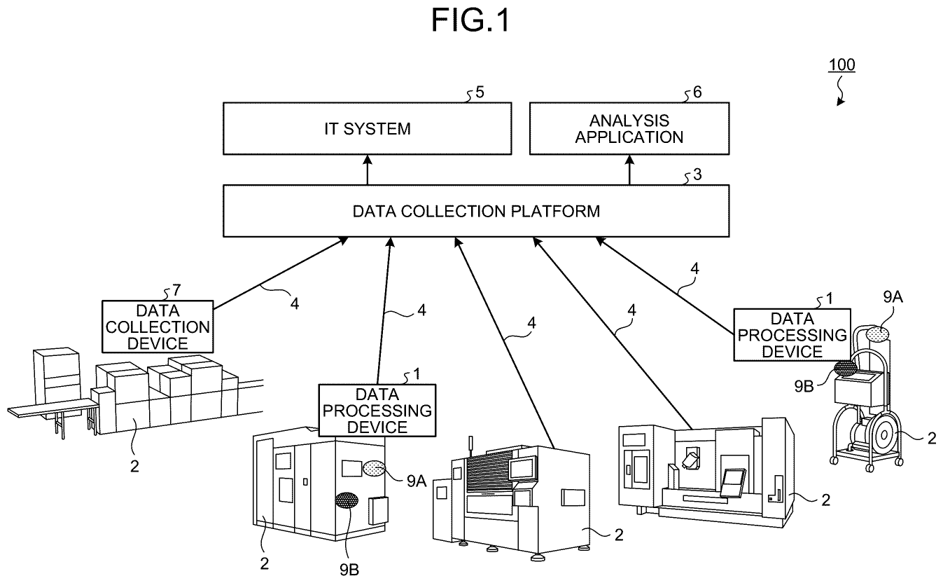

Hereinafter, the data processing device according to the present embodiment will be described in detail. FIG. 1 is a diagram illustrating a configuration example of a data collection system to which the data processing device according to the embodiment is applied. A data collection system 100 illustrated in FIG. 1 includes: a plurality of types of production facilities 2 such as a production line, a surface-mounting machine, a mold press apparatus, a mounter apparatus, a resin molding machine, and a machining center for metal working which are installed at a manufacturing site; a data collection platform 3 configured to collect data from the production facilities 2 via a wired or wireless network 4; an information technology (IT) system 5 that is a production management system, a manufacturing execution system (MES), or the like; and an analysis application 6 that is an application configured to perform data analysis or the like. The data collection platform 3 is software capable of collecting manufacturing data without depending on a type of the production facility 2, and is provided in an Industrial Personal Computer (IPC) that is an industrial version PC. The data collection platform 3 passes manufacturing data collected from the production facility 2 to the IT system 5 and the analysis application 6. For example, the IT system 5 acquires manufacturing data from the data collection platform 3, to manage production results. For example, the analysis application 6 acquires manufacturing data from the data collection platform 3, and analyzes the manufacturing data to identify a defect cause when the acquired manufacturing data includes information indicating that a defect has occurred in a manufactured product.

Here, when acquiring manufacturing data from the production facility 2, the data collection platform 3 acquires the manufacturing data by the following methods (1) to (3) in accordance with a state of a function of the production facility 2 from which the data is acquired.
(1) In a case where the production facility 2 has a function of directly outputting data to the data collection platform 3 via the network 4, the data collection platform 3 acquires manufacturing data from the production facility 2 via the network 4.
(2) In a case where the production facility 2 has a function of outputting data to the outside, but the data collection platform 3 does not have a function of receiving the data outputted by the production facility 2, the data collection platform 3 acquires manufacturing data of the production facility 2 via a data collection device 7 that converts the manufacturing data outputted from the production facility 2 into a data format receivable by the data collection platform 3.
(3) In a case where the production facility 2 does not have a function of outputting data to the outside, or where the facility 2 has a function of outputting data to the outside but the data output function is limited, the data collection platform 3 acquires manufacturing data via the data processing device 1 according to the present embodiment described above.

As described above, the data processing device 1 determines an operational status of the production facility 2 by collecting and analyzing observation data of sound and mechanical vibration caused from the production facility 2. The data processing device 1 generates manufacturing data on the basis of a determination result of the operational status, and transmits the manufacturing data to the data collection platform 3 via the network 4. For example, in a case of generating manufacturing data on the basis of sound and mechanical vibration caused in the production facility 2, the data processing device 1 observes sound and mechanical vibration caused in a series of operations (that is assumed to be composed of an A-operation, a B-operation, and a C-operation) of the production facility 2 with a sound collection microphone 9A and a vibration sensor 9B attached to the production facility 2, and classifies the obtained observation data first in a range corresponding to each of the A-operation, the B-operation, the C-operation, and a completion operation. Next, the data processing device 1 analyzes each piece of the observation data after the classification, and learns how observation data obtained when each operation is executed is. After completion of the learning, when observation data is newly acquired, the data processing device 1 determines the operational status of the production facility 2 on the basis of a learning result. That is, the data processing device 1 determines whether the learned operation has occurred. Upon detecting the occurrence of the operation in the determination of the operational status, the data processing device 1 generates a determination result including information on a time at which the detected operation has occurred, and outputs the generated determination result as manufacturing data. Note that, the data processing device 1 can also detect an operation anomaly of the production facility 2 from the observation data and the learning result, and output the detection result as anomaly data. In order for the data processing device 1 to be able to detect an operation anomaly, learning of observation data obtained when the operation anomaly occurs is performed in advance.

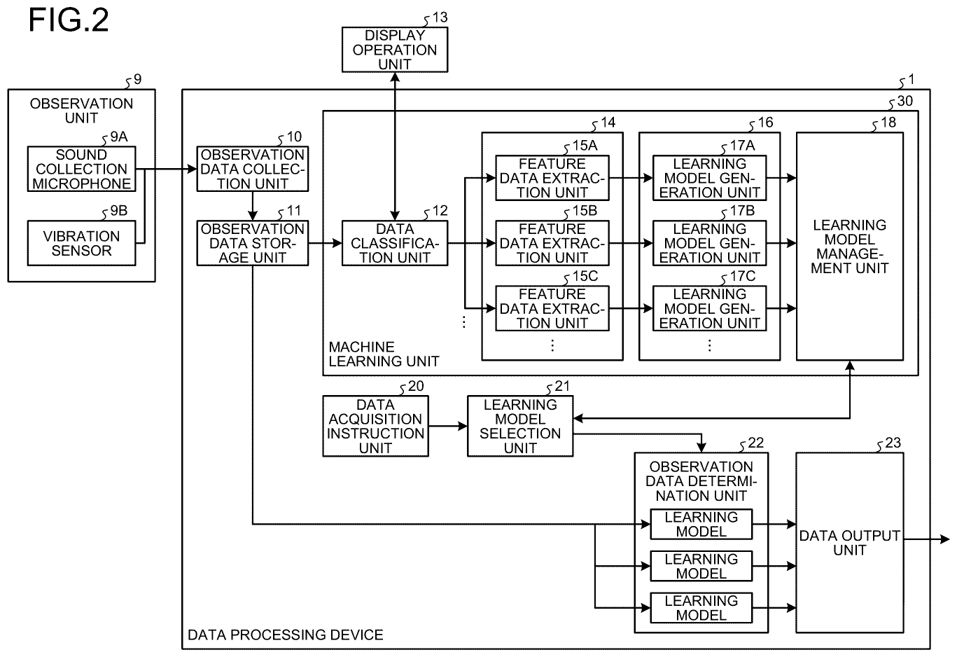

FIG. 2 is a diagram illustrating a configuration example of the data processing device 1 according to the embodiment. The data processing device 1 includes an observation data collection unit 10, an observation data storage unit 11, a data acquisition instruction unit 20, a learning model selection unit 21, an observation data determination unit 22, a data output unit 23, and a machine learning unit 30. The machine learning unit 30 includes a data classification unit 12, a data analysis unit 14 configured to include feature data extraction units 15A, 15B, 15C, . . . , a learning processing unit 16 configured to include learning model generation units 17A, 17B, 17C, . . . , and a learning model management unit 18. In addition, the observation data collection unit 10 is connected to an observation unit 9 comprised of the sound collection microphone 9A and the vibration sensor 9B each of which is attached to the production facility 2. The data classification unit 12 of the machine learning unit 30 is connected to a display operation unit 13. Note that the configuration may be made such that the display operation unit 13 is built in the data processing device 1. Further, hereinafter, when the feature data extraction units 15A, 15B, 15C, . . . are described without distinction between them, they are collectively described as a feature data extraction unit 15. In addition, in a case where the learning model generation units 17A, 17B, 17C, . . . are described without distinction between them, they are collectively described as a learning model generation unit 17.

The observation data collection unit 10 collects observation data of vibration caused during operation of the production facility. Specifically, the observation data collection unit 10 collects observation data of sound measured by the sound collection microphone 9A and observation data of mechanical vibration measured by the vibration sensor 9B from the sound collection microphone 9A and the vibration sensor 9B, as the observation data of vibration. Note that the observation data collection unit 10 only has to collect observation data from at least one of the sound collection microphone 9A and the vibration sensor 9B. That is, the observation data collection unit 10 collects observation data of at least one of sound and mechanical vibration caused in the production facility 2. The observation data collected by the observation data collection unit 10 is stored in the observation data storage unit 11.

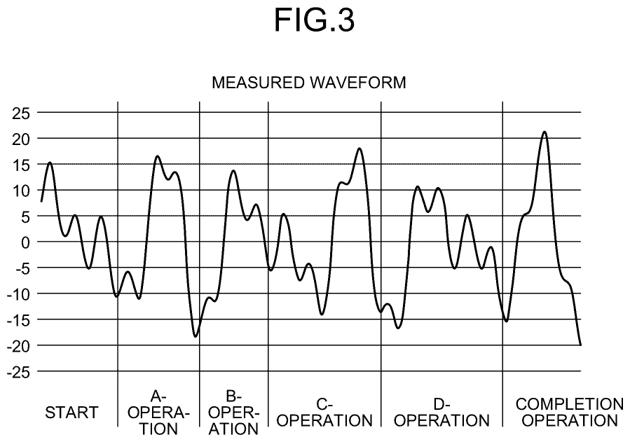

The data classification unit 12 reads observation data from the observation data storage unit 11, and classifies the read observation data on the basis of each of a series of operations executed by the production facility 2. Specifically, the data classification unit 12 performs the classification on the basis of a start timing and an end timing of each of the series of operations executed by the production facility 2. For example, in a case where the series of operations corresponding to the observation data read by the data classification unit 12 includes the A-operation, the B-operation, the C-operation, and the completion operation, the data classification unit 12 classifies the observation data into: observation data of a section in which the A-operation has been executed; observation data of a section in which the B-operation has been executed; observation data of a section in which the C-operation has been executed; and the observation data of a section in which the completion operation has been executed, to thereby generate analysis target data corresponding to each of the operations. Here, each of the operations executed by the production facility 2 corresponds to a management item that is a unit in which the data processing device 1 determines the operational state of the production facility. That is, the data classification unit 12 classifies the observation data read from the observation data storage unit 11 into a plurality of pieces of analysis target data for each management item. Note that setting of the sections into which the observation data is classified is performed by, for example, a user. In a case where the user sets the sections, the data classification unit 12 displays the observation data read from the observation data storage unit 11 on the display operation unit 13 in a format as illustrated in FIG. 3, with time being set on a horizontal axis and an amplitude being set on a vertical axis. FIG. 3 is a chart illustrating an example of a screen displayed by the display operation unit 13. FIG. 3 is a screen display example after the user performs an operation for setting the sections, and more specifically is a screen display example in a case where the user sets the sections of “start”, “A-operation”, “B-operation”, “C-operation”, “D-operation”, and “completion operation” for a waveform of the observation data read from the observation data storage unit 11. The names of the sections (“start”, “A-operation”, “B-operation”, . . . ) may be freely given by the user via the display operation unit 13. The user performs setting of the sections, assignment of names to the set sections, and the like with use of an input device such as a mouse or a keyboard.

Note that, in a case where there is no change in the series of operations executed by the production facility 2 and a required time for each operation (the start, the A-operation, the B-operation, . . . ) when the series of operations is executed is constant, the data classification unit 12 may set the sections on the basis of the order in which the operations are executed and the required time for each of the series of operations.

In the present embodiment, the description will be continued assuming that the user sets each section described above. In addition, in order to simplify the description, the section to be set by the user is assumed to be a section corresponding to each of the A-operation, the B-operation, the C-operation, and the completion operation. That is, the series of operations executed by the production facility 2 is assumed to be the A-operation, the B-operation, the C-operation, and the completion operation.

Upon receiving, from the user, an operation of setting a waveform portion, that is, a section, indicating the A-operation, the B-operation, the C-operation, and the completion of the production facility 2 for a waveform of displayed observation data, the display operation unit 13 notifies the data classification unit 12 of operation contents received from the user. In accordance with the operation contents notified from the display operation unit 13, the data classification unit 12 generates analysis target data corresponding to the A-operation by adding a tag indicating the A-operation to observation data in a section set and designated for the A-operation, and outputs the analysis target data to the data analysis unit 14 (for example, the feature data extraction unit 15A). Similarly, the data classification unit 12 generates analysis target data corresponding to the B-operation by adding a tag indicating the B-operation to observation data in a section set for the B-operation and outputs the analysis target data to the data analysis unit 14 (for example, the feature data extraction unit 15B), generates analysis target data corresponding to the C-operation by adding a tag indicating the C-operation to observation data in a section set for the C-operation and outputs the analysis target data to the data analysis unit 14 (for example, the feature data extraction unit 15C), and generates analysis target data corresponding to the completion operation by adding a tag indicating the completion operation to observation data in a section set for the completion operation and outputs the analysis target data to the data analysis unit 14 (for example, the feature data extraction unit 15x). Note that a description for the feature data extraction unit 15x is omitted in FIG. 2. A section designation operation performed by the user via the display operation unit 13 is performed by the user grasping a flow of the operation in the production facility 2 and a timing thereof, and estimating a waveform of each operation on the basis of the timing (a time interval) at which a feature appears in the waveform. Note that the display operation unit 13 is realized by a display device and an input device (a mouse, a keyboard, and the like), by which an operation of the user is received from the input device, but the present disclosure is not necessarily limited to this example, the display operation unit 13 may be realized by a device in which the display device and the input device are integrated, such as a touch panel.

Further, upon receiving, from the user, an operation of setting a waveform portion (a section) indicating a defect of the production facility 2, of the waveform of the displayed observation data, the display operation unit 13 notifies the data classification unit 12 of a section in which a defect has occurred, that is the set section. Upon receiving the notification on the section in which the defect has occurred, the data classification unit 12 adds a tag indicating the occurrence of the defect to observation data in the indicated section on the notification (hereinafter, referred to as a defect occurrence section), and outputs the data obtained by the addition to the data analysis unit 14.

The user's operation of designating the defect occurrence section via the display operation unit 13 is performed, for example, by the display operation unit 13 superimposingly displaying one waveform of observation data in which no defect has occurred and another waveform of observation data in which a defect has occurred with their time axes coinciding with each other, and the user designating a section in which the one and the other of observation data differ in waveform shape, as the defect occurrence section.

Note that, in the present embodiment, the user operates the display operation unit 13 to designate the defect occurrence section, but the present disclosure is not necessarily limited to this example, and the data classification unit 12 may compare a waveform of observation data for comparison in which no defect has occurred with a waveform of observation data in which whether or not a defect has occurred is unknown, and identify the defect occurrence section from a difference between the two waveforms. That is, the designation of the defect occurrence section is performed without any determination of the user and without any recognition of the user, and the data analysis unit 14 can acquire observation data in the defect occurrence section, that is, observation data attached with a tag indicating the defect occurrence.

From the observation data received from the data classification unit 12, the feature data extraction unit 15 extracts feature data representing a feature of an operation corresponding to this observation data. For example, in a case where the operation corresponding to the observation data received from the data classification unit 12 is the A-operation, that is, in a case where observation data obtained during execution of the A-operation is inputted from the data classification unit 12, the feature data extraction unit 15 analyzes the observation data to extract feature data representing the feature of the A-operation. In this example, the feature data extraction unit 15 extracts feature data by, for example, unsupervised machine learning, and an algorithm thereof does not have any particular restriction. The feature data extraction unit 15 outputs the extracted feature data to the subsequent learning model generation unit 17.

The learning model generation unit 17 generates a learning model using the feature data extracted from the observation data by the feature data extraction unit 15. For example, in a case where the feature data is extracted from observation data corresponding to the A-operation, the learning model generation unit 17 generates a learning model for detecting the A-operation. Note that an algorithm for generating the learning model in the learning model generation unit 17 does not have any particular restriction.

After generating the learning model, the learning model generation unit 17 stores the generated learning model into the learning model management unit 18 in association with information (hereinafter referred to as model-related information) related to the observation data from which the learning model has been generated. In this example, for example, the model-related information corresponds to: information indicating a type of observation data (which operation the section in which the observation data is obtained corresponds to), such as classification of operations including the A-operation, the B-operation, the C-operation, and the completion operation, and a tag added to the observation data described above; information from the observation data is outputted such as a name of the production facility 2 in which the observation data has been acquired; information on the order in which the A-operation, the B-operation, the C-operation, and the completion operation are executed; and the like.

Note that, in the present embodiment, as illustrated in FIG. 2, the data analysis unit 14 is comprised of two or more feature data extraction units 15 (the feature data extraction units 15A, 15B, 15C, . . . ) corresponding to individual operations (the A-operation, the B-operation, the C-operation, . . . ), and further, the learning processing unit 16 is comprised of two or more learning model generation units 17 (the learning model generation units 17A, 17B, 17C, . . . ) corresponding to individual operations, but the present disclosure is not necessarily limited to this example. For example, the data analysis unit 14 may be comprised of a single feature data extraction unit 15. In this case, the single feature data extraction unit 15 extracts feature data from observation data corresponding to each operation while switching processing. The feature data extraction unit 15 switches processing to be executed in accordance with a tag attached to the inputted observation data. Although a case where the data analysis unit 14 is comprised of the single feature data extraction unit 15 has been described, the manner in that case applies to a case where the learning processing unit 16 is comprised of a single learning model generation unit 17. That is, the single learning model generation unit 17 generates a learning model corresponding to each operation.

The data acquisition instruction unit 20 receives, from the user, an operation of instructing to acquire manufacturing data from the production facility 2, and transmits instruction information indicating instruction contents to the learning model selection unit 21. The instruction information includes information such as a name of the production facility 2 in which data is acquired and a type of data to be acquired. The learning model selection unit 21 reads a relevant learning model from the learning model management unit 18 on the basis of the received instruction information, and outputs the read learning model to the observation data determination unit 22. Specifically, the learning model selection unit 21 reads the learning model related to the received instruction information from the learning model management unit 18 on the basis of the model-related information (information related to classification of operations, tag information, type information of observation data, and the like) assigned to the learning model, and stores the read learning model into the observation data determination unit 22.

The observation data determination unit 22 acquires observation data from the observation data storage unit 11, and determines an operational status of the production facility 2 on the basis of the acquired observation data and each learning model. That is, the observation data determination unit 22 determines whether the operation corresponding to each learning model has been executed in the production facility 2. Upon detecting the operation corresponding to each learning model, the observation data determination unit 22 associates time data indicating a time at which the detected operation has occurred with information on the identified operation, and outputs the resultant to the data output unit 23 as a determination result. The information on the identified operation is information indicating any one of the above-described operations (the A-operation, the B-operation, . . . ) or information indicating an anomaly operation. The observation data determination unit 22 outputs the determination result for each learning model to the data output unit 23.

The data output unit 23 transmits the determination result for each learning model generated by the observation data determination unit 22 to the data collection platform 3, as manufacturing data.

Next, an operation of the data processing device 1 will be described below with the operation being divided into a learning stage and a determination stage.

### (Operation in Learning Stage)

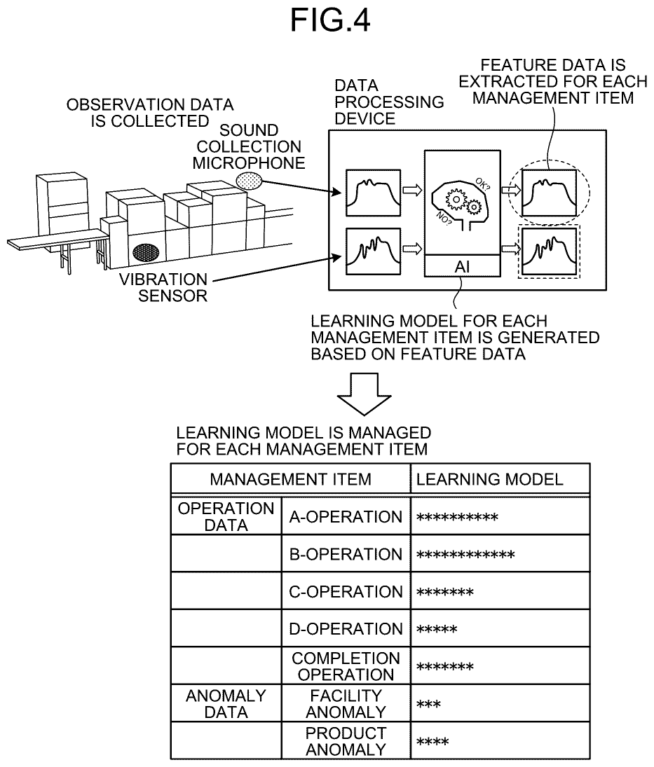

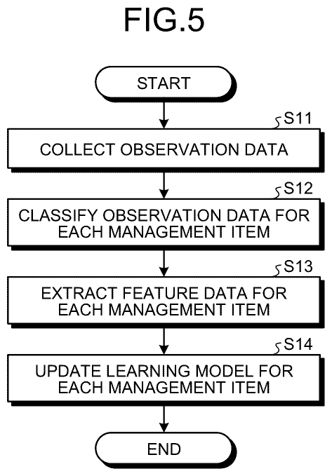

With reference to FIGS. 4 and 5, an operation in the learning stage of the data processing device 1 will be described. FIG. 4 is a diagram illustrating an operation outline of the learning stage of the data processing device 1. FIG. 5 is a flowchart illustrating an example of the operation in the learning stage of the data processing device 1.

As illustrated in FIG. 4, the data processing device 1 collects observation data from the sound collection microphone 9A and vibration sensor 9B attached to the production facility 2, extracts feature data for each management item from the collected observation data, and generates a learning model for each management item. The management item represents a range in which the feature data is extracted, and corresponds to a unit in which the operational status of the production facility 2 is determined. In another expression, the management item corresponds to a section into which the data classification unit 12 classifies the observation data, the section being previously described.

The data processing device 1 generates a learning model for each management item by repeatedly executing the processing illustrated in FIG. 5 for a sufficient number of times.

As illustrated in FIG. 5, the data processing device 1 first collects observation data (step S11). Specifically, the observation data collection unit 10 collects observation data from the sound collection microphone 9A and the vibration sensor 9B of the observation unit 9.

Next, the data processing device 1 classifies the observation data for each management item (step S12). Specifically, the data classification unit 12 classifies the observation data into pieces of analysis target data each of which is observation data for each of sections corresponding individually to a series of operations executed by the production facility 2 as a data acquisition source, in accordance with an instruction from the user.

In step S12, for example, the observation data is classified by adding a tag to the observation data in a procedure illustrated in (a) or (b) below.
(a) The data processing device 1 causes the display operation unit 13 to display a captured image of a camera provided in the production facility 2 and a waveform of the observation data, and the user compares the captured image with the waveform of the observation data in time series, and sets a section corresponding to each of the series of operations executed by the production facility 2 on the basis of the operation in the production facility 2 that can be checked from the captured image. The data classification unit 12 adds a tag indicating the set section to the observation data. The tag used herein corresponds to a tag indicating the A-operation, a tag indicating the B-operation, and so on described above.
(b) The data processing device 1 causes the display operation unit 13 to display a waveform of the observation data obtained during operation of the production facility 2 and an operation procedure in the production facility 2, and the user compares the waveform of the observation data with the operation procedure, and sets a section corresponding to each of the series of operations executed by the production facility 2 on the basis of a shape feature of the waveform of the observation data. The data classification unit 12 adds a tag indicating the set section to the observation data. Note that the setting of the section in this manner is performed on the basis of experience of an operator (the user) by which this shape in waveform must appear when this operation is performed in the production facility 2.

Next, the data processing device 1 extracts feature data for each management item (step S13). Specifically, each of the feature data extraction units 15 extracts feature data from each of the pieces of observation data classified in step S12.

Then, the data processing device 1 updates a learning model for each management item (step S14). Specifically, the learning model generation unit 17 performs learning using each piece of feature data extracted in step S13 as learning data, and updates the learning model for each management item.

### (Operation in Determination Stage)

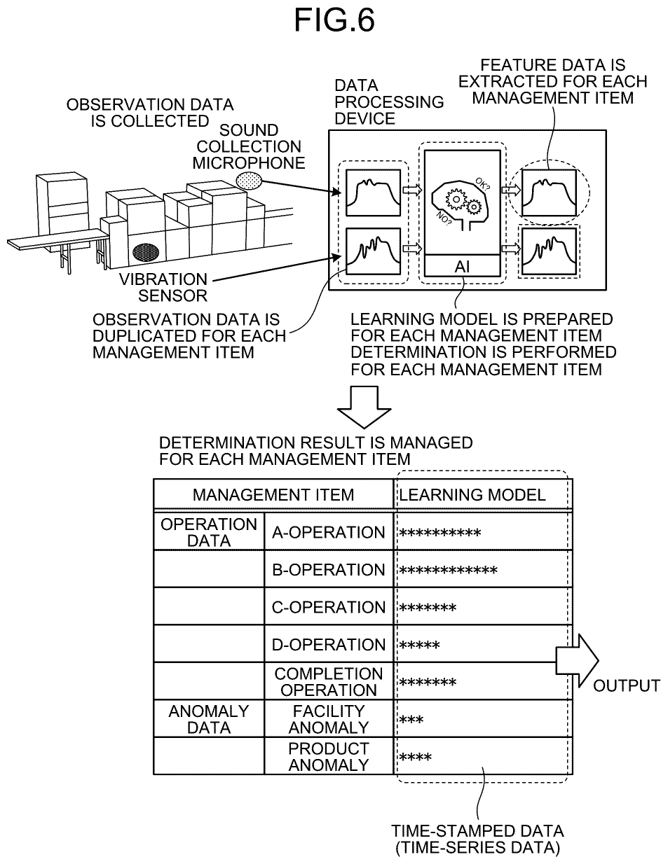

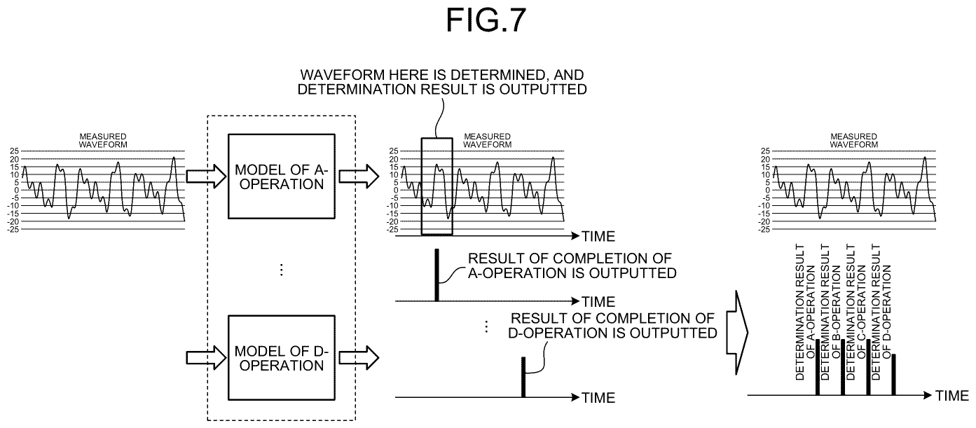

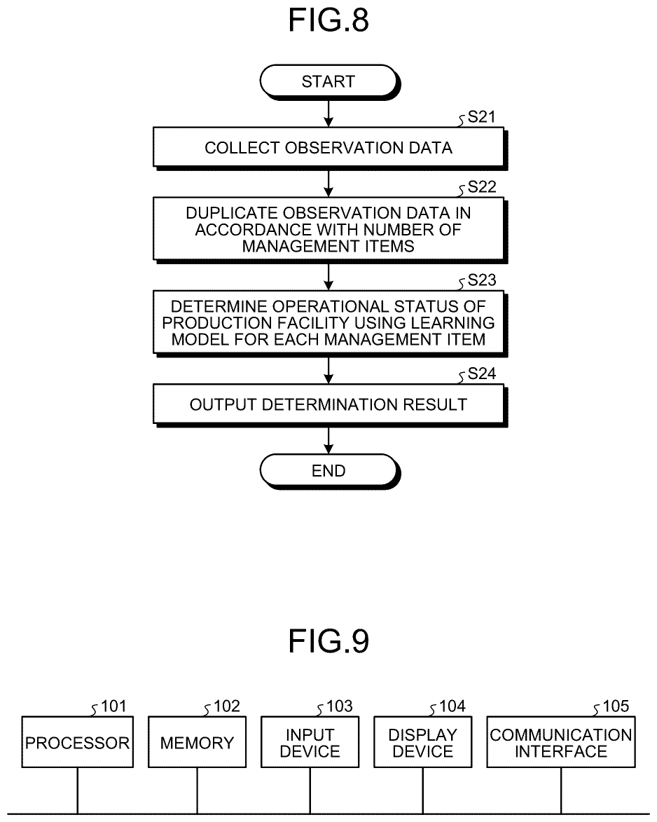

With reference to FIGS. 6, 7, and 8, an operation in the determination stage of the data processing device 1 will be described. FIG. 6 is a first diagram illustrating an operation outline of the determination stage of the data processing device 1. FIG. 7 is a second diagram illustrating an operation outline of the determination stage of the data processing device 1. FIG. 8 is a flowchart illustrating an example of the operation in the determination stage of the data processing device 1. Note that the operation in the determination stage is executed in a state where the operation in the learning stage described above has been executed and generation of the learning model has been completed.

As illustrated in FIG. 6, the data processing device 1 collects observation data from the sound collection microphone 9A and vibration sensor 9B attached to the production facility 2, and duplicates the collected observation data. Then, as illustrated in FIGS. 6 and 7, the data processing device 1 determines observation data with use of a learning model prepared for each management item (an operation to be executed by the production facility 2), and detects an operation executed by the production facility 2. The data processing device 1 outputs a determination result for each management item. The determination result is time-stamped data, and includes information on an operation detected using each learning model and information on an occurrence time of the detected operation. Since the information on the occurrence time of the detected operation is included in the determination result, for example, as illustrated in FIG. 7, it is possible to notify the user of the detected operation in a form in which the operations detected are arranged on a time axis. The user who has checked this notification can recognize that a defect has occurred in the production facility 2 if one or more of a series of the operations that must be executed by the production facility 2 are not detected. For example, if the C-operation is not detected in a case where a series of operations executed by the production facility 2 is the A-operation, the B-operation, the C-operation, and the completion operation, the user can recognize a state where the C-operation is not normally performed due to some defect of the production facility 2.

In the operation in the determination stage, as illustrated in FIG. 8, the data processing device 1 first collects observation data (step S21). Specifically, the observation data collection unit 10 collects observation data from the sound collection microphone 9A and the vibration sensor 9B of the observation unit 9.

Next, the data processing device 1 duplicates the observation data in accordance with the number of management items (step S22), and determines the operational status of the production facility 2 with use of the learning model for each management item (step S23). Specifically, the observation data determination unit 22 reads the observation data from the observation data storage unit 11, performs duplication of it, and produces pieces of observation data, the number of which is equal to the number of management items. Note that the number of management items corresponds to the number of learning models stored in the observation data determination unit 22. Next, the observation data determination unit 22 analyzes the observation data with use of each of the learning models, and determines the operational status for each management item, that is, whether or not the operation corresponding to the management item has been performed. Then, the data processing device 1 outputs a determination result (step S24). Specifically, the data output unit 23 transmits a series of determination results for each management item to the data collection platform 3, as manufacturing data.

Note that the manufacturing data outputted by the data output unit 23 may include anomaly data of the production facility 2. That is, the data processing device 1 may be configured to use some of multiple learning models for determination of the observation data as a learning model or learning models for detecting an anomaly operation of the production facility 2, and output, when an operation anomaly has occurred in the production facility 2, anomaly data indicating the fact, as the manufacturing data, in addition to manufacturing data when the production facility 2 is operating normally.

The manufacturing data outputted from the data processing device 1 is used for the following purposes, for example.

The IT system 5 illustrated in FIG. 1 includes a production scheduler that creates a production plan, and an MES that collects an execution instruction of the production plan and results. The MES collects manufacturing data from the data processing device 1 or the like via the data collection platform 3. In a case where a difference occurs between the production plan created by the production scheduler and the production result, the production scheduler analyzes the manufacturing data collected from the data processing device 1 and the like, determines whether there is something that should be changed in an operation condition and setting of the production facility 2, and makes a change when there is something that should be changed. As described above, the manufacturing data includes the determination result of each of the operations (the A-operation, the B-operation, . . . ) and the information on the time at which each operation occurred. Therefore, the production scheduler changes settings of set-up time, waiting time of a workpiece, and the like on the basis of the time information included in the manufacturing data, for example. As a result, productivity in the production facility 2 can be improved.

As described above, the data processing device 1 according to the present embodiment includes: the observation data collection unit 10 that collects observation data from various kinds of sensors attached to the production facility 2; and the machine learning unit 30 that extracts feature data for each management item from the observation data on the basis of a series of operations executed by the production facility 2, and analyzes each piece of the extracted observation data to generate a learning model for each management item. In addition, the data processing device 1 includes the observation data determination unit 22 that determines the operation state for each management item on the basis of the observation data collected by the observation data collection unit 10 and the learning model. The data processing device 1 according to the present embodiment can individually determine a status of each of a series of operations executed by the production facility 2.

Next, hardware for realizing the data processing device 1 according to the present embodiment will be described. FIG. 9 is a diagram illustrating an example of hardware that realizes the data processing device 1. The data processing device 1 can be realized by a processor 101, a memory 102, an input device 103, a display device 104, and a communication interface 105 illustrated in FIG. 9. An example of the processor 101 is a central processing unit (CPU); which is also be referred to as a central processing device, a processing device, an arithmetic device, a microprocessor, a microcomputer, or a digital signal processor (DSP)) or a system large scale integration (LSI). Examples of the memory 102 include a nonvolatile or volatile semiconductor memory such as a random access memory (RAM), a read only memory (ROM), and a flash memory, a magnetic disk, and the like. Examples of the input device 103 include a mouse, a keyboard, and the like. Examples of the display device 104 include a liquid crystal display and the like. Note that the input device 103 and the display device 104 may be configured as a touch panel.

The observation data collection unit 10, the learning model selection unit 21, the observation data determination unit 22, the data output unit 23, and the machine learning unit 30 of the data processing device 1 are implemented by the processor 101 executing a program configured for operations of these units. The program configured for operations of the observation data collection unit 10, the learning model selection unit 21, the observation data determination unit 22, the data output unit 23, and the machine learning unit 30 is stored in the memory 102 in advance. By reading the program from the memory 102 and executing it, the processor 101 operates as the observation data collection unit 10, the learning model selection unit 21, the observation data determination unit 22, the data output unit 23, and the machine learning unit 30.

The observation data storage unit 11 is realized by the memory 102. In addition, the memory 102 holds the program described above and is also used as a temporary memory when the data processing device 1 executes various kinds of processes. The data acquisition instruction unit 20 is realized by the input device 103.

The communication interface 105 is used when the data processing device 1 transmits data to the data collection platform 3.

Note that the program described above is stored in the memory 102 in advance, but the present disclosure is not necessarily limited to this example. The program described above may have a form of being supplied to the user in a state where the program is written in a recording medium such as a compact disc ROM (CD-ROM) or a digital versatile disc ROM (DVD-ROM), and installed in the memory 102 by the user. Furthermore, the above-described program may have a form of being provided to the user via a network such as the Internet.

The configuration illustrated in the above embodiment illustrates just one example, which can be combined with other publicly known techniques and partially omitted and/or modified without departing from the scope of the present disclosure.

### REFERENCE SIGNS LIST

1 data processing device; 2 production facility; 3 data collection platform; 4 network; 5 IT system; 6 analysis application; 7 data collection device; 9 observation unit; 9A sound collection microphone; 9B vibration sensor; 10 observation data collection unit; 11 observation data storage unit; 12 data classification unit; 13 display operation unit; 14 data analysis unit; 15, 15A, 15B, 15C feature data extraction unit; 16 learning processing unit; 17, 17A, 17B, 17C learning model generation unit; 18 learning model management unit; 20 data acquisition instruction unit; 21 learning model selection unit; 22 observation data determination unit; 23 data output unit; 30 machine learning unit; 100 data collection system.

1. A data processing device comprising:
observation data collection circuitry to collect observation data on vibration caused during operation of a production facility;
data classification circuitry to classify the observation data on a time axis based on each of a series of operations executed by the production facility to generate a plurality of pieces of analysis target data for each of management items each of which is a circuitry in which an operational status of the production facility is to be determined;
feature data extraction circuitry to analyze each of the pieces of analysis target data and extract feature data representing a feature of the management item;
learning model generation circuitry to generate, based on the feature data, a learning model for determination of an operational status of the production facility for each of the management items;
observation data determination circuitry to determine an operational status of the production facility for each of the management items, based on a learning model for each of the management items and observation data newly collected by the observation data collection circuitry, the learning model being generated by the learning model generation circuitry; and
data output circuitry to output a determination result of an operational status for each of the management items, the determination result being obtained by the observation data determination circuitry.

2. The data processing device according to claim 1, wherein
the observation data determination circuitry generates a determination result including: information indicating whether or not the production facility has executed the management item; and information on an occurrence time of a management item executed by the production facility.

3. The data processing device according to claim 1, wherein
each of the management items represents one operation of a series of operations to be executed by the production facility.

4. The data processing device according to claim 1, wherein
the feature data extraction circuitry extracts feature data when an operation anomaly occurs in the production facility, and
the learning model generation circuitry generates a learning model for detection of an operation anomaly of the production facility based on feature data when an operation anomaly occurs in the production facility, the feature data being extracted by the feature data extraction circuitry.

5. The data processing device according to claim 1, wherein
the observation data determination circuitry duplicates observation data collected by the observation data collection circuitry to generate pieces of observation data, the number of the pieces of observation data being equal to the number of learning models for each of the management items, and the observation data determination circuitry determines an operational status of the production facility for each of the management items based on each of the generated pieces of observation data and each learning model for each of the management items.

6. A data processing method in which a data processing device processes data outputted from a production facility, the data processing method comprising:
an observation data collection step of collecting observation data on vibration caused during operation of the production facility;
a data classification step of classifying the observation data on a time axis based on each of a series of operations executed by the production facility to generate a plurality of pieces of analysis target data for each of management items each of which is circuitry in which an operational status of the production facility is to be determined;
a feature data extraction step of analyzing each of the pieces of analysis target data and extracting feature data representing a feature of the management item;
a learning model generation step of generating, based on the feature data, a learning model for determination of an operational status of the production facility for each of the management items;
an observation data determination step of determining an operational status of the production facility for each of the management items, based on a learning model for each of the management items and observation data newly collected in the observation data collection step, the learning model being generated in the learning model generation step; and
an output step of outputting a determination result of an operational status for each of the management items, the determination result being obtained in the observation data determination step.

7. A non-transitory storage medium in which a program configured to process data outputted from a production facility is stored, the program causing a computer to execute:
an observation data collection step of collecting observation data on vibration caused during operation of a production facility;
a data classification step of classifying the observation data on a time axis based on each of a series of operations executed by the production facility to generate a plurality of pieces of analysis target data for each of management items each of which is circuitry in which an operational status of the production facility is to be determined;
a feature data extraction step of analyzing each of the pieces of analysis target data and extracting feature data representing a feature of the management item;
a learning model generation step of generating, based on the feature data, a learning model for determination of an operational status of the production facility for each of the management items;
an observation data determination step of determining an operational status of the production facility for each of the management items, based on a learning model for each of the management items and observation data newly collected in the observation data collection step, the learning model being generated in the learning model generation step; and
an output step of outputting a determination result of an operational status for each of the management items, the determination result being obtained in the observation data determination step.

8. The data processing device according to claim 2, wherein
each of the management items represents one operation of a series of operations to be executed by the production facility.

9. The data processing device according to claim 2, wherein
the feature data extraction circuitry extracts feature data when an operation anomaly occurs in the production facility, and
the learning model generation circuitry generates a learning model for detection of an operation anomaly of the production facility based on feature data when an operation anomaly occurs in the production facility, the feature data being extracted by the feature data extraction circuitry.

10. The data processing device according to claim 3, wherein
the feature data extraction circuitry extracts feature data when an operation anomaly occurs in the production facility, and
the learning model generation circuitry generates a learning model for detection of an operation anomaly of the production facility based on feature data when an operation anomaly occurs in the production facility, the feature data being extracted by the feature data extraction circuitry.

11. The data processing device according to claim 8, wherein
the feature data extraction circuitry extracts feature data when an operation anomaly occurs in the production facility, and
the learning model generation circuitry generates a learning model for detection of an operation anomaly of the production facility based on feature data when an operation anomaly occurs in the production facility, the feature data being extracted by the feature data extraction circuitry.

12. The data processing device according to claim 2, wherein
the observation data determination circuitry duplicates observation data collected by the observation data collection circuitry to generate pieces of observation data, the number of the pieces of observation data being equal to the number of learning models for each of the management items, and the observation data determination circuitry determines an operational status of the production facility for each of the management items based on each of the generated pieces of observation data and each learning model for each of the management items.

13. The data processing device according to claim 3, wherein
the observation data determination circuitry duplicates observation data collected by the observation data collection circuitry to generate pieces of observation data, the number of the pieces of observation data being equal to the number of learning models for each of the management items, and the observation data determination circuitry determines an operational status of the production facility for each of the management items based on each of the generated pieces of observation data and each learning model for each of the management items.

14. The data processing device according to claim 8, wherein
the observation data determination circuitry duplicates observation data collected by the observation data collection circuitry to generate pieces of observation data, the number of the pieces of observation data being equal to the number of learning models for each of the management items, and the observation data determination circuitry determines an operational status of the production facility for each of the management items based on each of the generated pieces of observation data and each learning model for each of the management items.

15. The data processing device according to claim 4, wherein
the observation data determination circuitry duplicates observation data collected by the observation data collection circuitry to generate pieces of observation data, the number of the pieces of observation data being equal to the number of learning models for each of the management items, and the observation data determination circuitry determines an operational status of the production facility for each of the management items based on each of the generated pieces of observation data and each learning model for each of the management items.

16. The data processing device according to claim 9, wherein
the observation data determination circuitry duplicates observation data collected by the observation data collection circuitry to generate pieces of observation data, the number of the pieces of observation data being equal to the number of learning models for each of the management items, and the observation data determination circuitry determines an operational status of the production facility for each of the management items based on each of the generated pieces of observation data and each learning model for each of the management items.

17. The data processing device according to claim 10, wherein
the observation data determination circuitry duplicates observation data collected by the observation data collection circuitry to generate pieces of observation data, the number of the pieces of observation data being equal to the number of learning models for each of the management items, and the observation data determination circuitry determines an operational status of the production facility for each of the management items based on each of the generated pieces of observation data and each learning model for each of the management items.

18. The data processing device according to claim 11, wherein
the observation data determination circuitry duplicates observation data collected by the observation data collection circuitry to generate pieces of observation data, the number of the pieces of observation data being equal to the number of learning models for each of the management items, and the observation data determination circuitry determines an operational status of the production facility for each of the management items based on each of the generated pieces of observation data and each learning model for each of the management items.
